(19) United States
(12) Patent Application Publication
(10) Pub. No.: US 2012/0166466 A1
(43) Pub. Date: Jun. 28, 2012

(54) METHODS AND APPARATUS FOR ADAPTIVE SEARCHING FOR HEALTHCARE INFORMATION

(75) Inventors: JOSEPH SLATER, Santa Clara, CA (US); TROY MCARTHUR, Afton, WI (US)

(73) Assignee: GENERAL ELECTRIC COMPANY, Schenectady, NY (US)

(21) Appl. No.: 12/979,847

(22) Filed: Dec. 28, 2010

(51) Int. Cl. G06F 17/30

(52) U.S. Cl. 707/767; 707/E17.074

(57) ABSTRACT

Methods and apparatus for adaptive searching for healthcare information are disclosed. An example apparatus for searching healthcare information systems includes a search term counter to receive searched query terms and to receive roles of searchers entering the searched query terms, the search term counter to maintain statistics indicative of usage of the searched query terms according to roles of the corresponding searchers; an interface to receive one or more characters entered into a search field of a search service by a user; a user identifier to determine a role associated with the user; and a term selector to reference the statistics using the role associated with the user to identify a query term for suggestion to the user based on the received one or more characters and the role of the user, wherein the interface is to facilitate presentation of the identified query term as a suggestion to the user for the search service.

### FIELD OF THE DISCLOSURE

This disclosure relates generally to healthcare information systems and, more particularly, to methods and apparatus for adaptive searching for healthcare information.

### BACKGROUND

Healthcare environments, such as hospitals and clinics, typically include information systems (e.g., hospital information systems (HIS), radiology information systems (RIS), storage systems, picture archiving and communication systems (PACS), etc.) to manage clinical information such as, for example, patient medical histories, imaging data, test results, diagnosis information, management information, and/or scheduling information. The information may be centrally stored or distributed at a plurality of locations. Healthcare practitioners may desire to access patient information or other information at various points in a healthcare workflow. Medical practitioners, such as doctors, surgeons, and other medical professionals, rely on the clinical information stored in such systems to assess the condition of a patient, to obtain information related to a health history of the patient, to provide immediate treatment to a patient in an emergency situation, to diagnose a disease or condition of a patient, and/or to provide any other medical treatment or attention. Such systems are often searched by various types of people and/or systems.

### SUMMARY

An example apparatus disclosed herein for searching healthcare information systems includes a search term counter to receive searched query terms and to receive roles of searchers entering the searched query terms, the search term counter to maintain statistics indicative of usage of the searched query terms according to roles of the corresponding searchers; an interface to receive one or more characters entered into a search field of a search service by a user; a user identifier to determine a role associated with the user; and a term selector to reference the statistics using the role associated with the user to identify a query term for suggestion to the user based on the received one or more characters and the role of the user, wherein the interface is to facilitate presentation of the identified query term as a suggestion to the user for the search service.

An example method disclosed herein for searching healthcare information systems includes receiving one or more characters entered into a search field of a search service; identifying a role associated with a user entering the one or more characters into the search field; selecting a query term to be suggested to the user based on the received one or more characters and the role associated with the searcher; and facilitating presentation of the selected query term to the user as a suggestion for use in the search service.

An example tangible machine readable medium disclosed herein has instructions stored thereon that, when executed cause a machine to at least receive searched query terms and to receive roles of searchers entering the searched query terms; maintain statistics indicative of usage of the searched query terms according to roles of the corresponding searchers; receive one or more characters entered into a search field of a search service by a user; determine a role associated with the user; and reference the statistics using the role associated with the user to identify a query term for suggestion to the user based on the received one or more characters and the role of the user, wherein the interface is to facilitate presentation of the identified query term as a suggestion to the user for the search service.

### BRIEF DESCRIPTION OF THE DRAWINGS

FIG. 1 is a schematic illustration of an example information system within which the example methods, apparatus, systems and articles of manufacture described herein may be implemented.

FIG. 2 is a block diagram of an example apparatus that may be used to implement the example adaptive search module of FIG. 1.

FIG. 3 is a flow diagram representative of example machine-readable instructions that may be executed to implement the example search term counter of FIG. 2.

FIG. 4 is a flow diagram representative of example machine-readable instructions that may be executed to implement the example selection counter of FIG. 2.

FIG. 5 is a flow diagram representative of example machine-readable instructions that may be executed to implement the example search director of FIG. 2.

FIG. 6 is a block diagram of an example processor system that may be used to execute the machine-readable instructions of FIGS. 3-5 and/or to implement the example search adaptive module of FIGS. 1 and/or 2.

### DETAILED DESCRIPTION

Although the following discloses example methods, apparatus, systems, and articles of manufacture including, among other components, firmware and/or software executed on hardware, it should be noted that such methods, apparatus, and systems are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware implemented on-site and/or off-site via a network (e.g., an Internet space). Accordingly, while the following describes example methods, apparatus, systems, and/or articles of manufacture, the examples provided are not the only way(s) to implement such methods, apparatus, systems, and/or articles of manufacture.

Some search engines and/or services related thereto provide suggestions to a searcher based on text entered into a search field on a user interface. In some instances, the suggestions are implemented by automatically filling in the search filled based on a first portion of typed word or phrase. That is, suggestions are sometimes provided as the searcher is typing an entry into the search field. The suggestions can be provided in, for example, a drop down menu and/or as a list on a search results page. However, the provided suggestions are often directed to results irrelevant to the desired subject matter. If so, a user is required to wade through large amounts of irrelevant or otherwise unwanted search results.

Generally, the example methods, apparatus, systems and/or articles of manufacture disclosed herein provide adaptive searching capabilities that improve, for example, suggestions provided to a searcher related to query terms. To do so, the examples disclosed herein identify a searcher and customize suggestions provided thereto based on a role and/or responsibility of the searcher. Consequently, the suggestions provided to the searcher are tailored towards likely interests of the searcher. Additionally, in some examples, the provided suggestions are further tailored based on and/or supplemented by a set of structured healthcare terminology that is acceptable into a database that defines a particular list of terms for which a search may be performed. Additionally, in some examples, the provided suggestions are further tailored based on and/or supplemented by one or more content models that include, each including a plurality of terms and data associated with relationships established between the terms. Example methods, apparatus, systems, and/or articles of manufacture to implement and/or utilize the adaptive searching disclosed herein are described in greater detail below.

In the interest of brevity and clarity, throughout the following disclosure references will be made to an example computing platform 100. However, the methods, apparatus, systems and/or articles of manufacture disclosed herein for adaptive searching may be implemented by and/or within any number and/or type(s) of additional and/or alternative platforms, systems, servers, personal computers, terminals, client devices, etc. Such additional and/or alternative platforms, systems, servers, personal computers, terminals, client devices, etc. may be communicatively coupled via any number and/or type(s) of public and/or private networks, and/or may be located and/or implemented at any number and/or type(s) of different geographical locations. Further, presentations, screens and/or user interfaces generated by the examples disclosed herein may be presented at the computing platform 100 and/or at an access terminal and/or client device communicatively coupled to the computing platform 100.

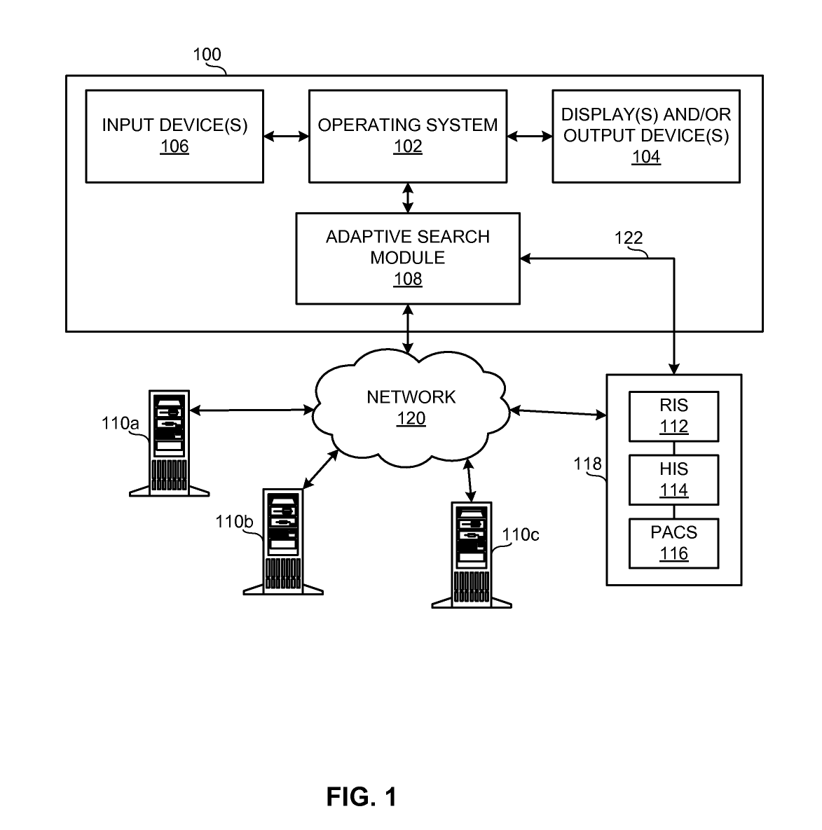

FIG. 1 illustrates the example computing platform 100. To enable a user, such as a healthcare practitioner (e.g., a radiologists, a physician, a surgeon, an oncologist, a technician, an administrator, etc.) to interact with the example computing platform 100, the computing platform 100 of FIG. 1 includes an operating system 102, any number and/or type(s) of display(s) and/or output device(s) 104, and any number and/or type(s) of input device(s) 106. The example operating system 102 of FIG. 1 enables information (e.g., clinical records, medical records, test results, images, windows, screens, interfaces, dialog boxes, etc.) to be displayed at the display(s) and/or output device(s) 104, and to allow a user to control, configure and/or operate the example computing platform 100 via the input device(s) 106. The user provides and/or makes inputs and/or selections via the input device(s) 106. Example input devices 106 include, but are not limited to, a keyboard, a touch screen, a trackball and/or a mouse, a microphone coupled to a voice recognition module, etc.

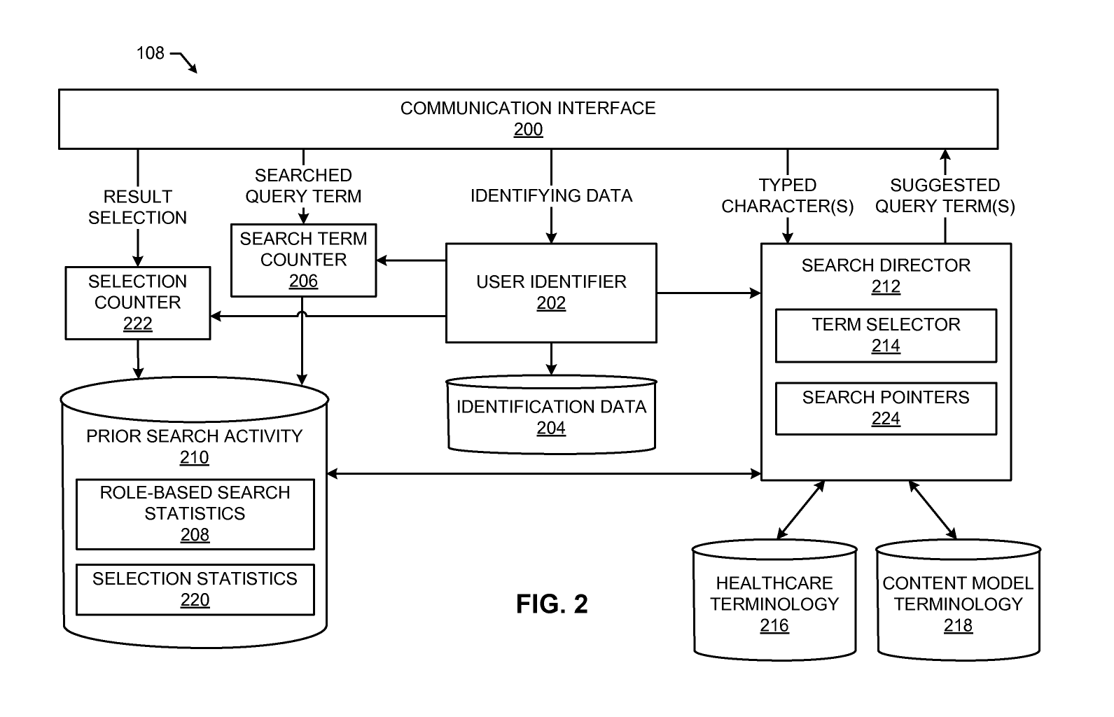

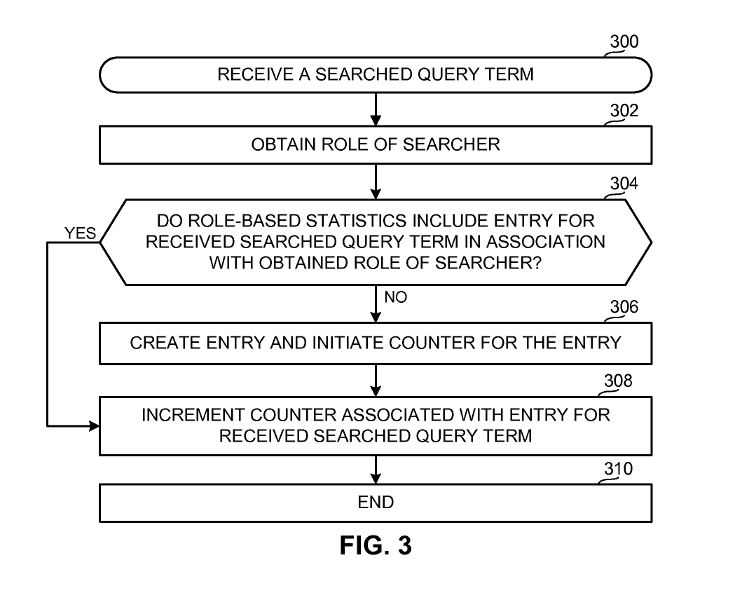

To implement the example methods, apparatus, systems, and/or articles of manufacture disclosed herein, the example computing platform 100 includes an adaptive search module 108. As described in greater detail below in connection with FIGS. 2 and 3, the example adaptive search module 108 enables the user to search a plurality of sources including, for example, one or more web servers 110a-c, a radiology information systems (RIS) 112, a hospital information systems (HIS) 114, a picture archiving and communication systems (PACS) 116. The RIS 112, the HIS 114 and the PACS 116 are referred to herein collectively as a clinical records system 118. However, the RIS 112, the HIS 114 and the PACS 116 can be implemented and/or utilized by the examples disclosed herein separately, as well as collectively. Further, the clinical records system 118 can be implemented as part of an information system in which the example computing platform 100 is implemented and/or the clinical system 118 may be implemented in an information system disparate from the system in which the example computing platform 100 is implemented. That is, the example clinical records system 118 may include and/or be in communication with additional record database(s) and may be capable of sharing data among the additional record database(s). For example, the example clinical records system 118 may be implemented as part of an Integrating the Healthcare Enterprise (IHE) Cross-Enterprise Document Sharing (XDS) integration profile, a health information exchange (HIE), a regional health information organization (RHIO), and/or any other system configured to facilitate sharing (e.g., registration, distribution, access, etc.) of healthcare data among the healthcare enterprises. Additionally or alternatively, the example clinical records system 118 may be implemented in a healthcare data system not having information sharing capabilities, such as a standalone physician office, a clinic or a hospital having a central data system.

The example adaptive search module 108 and/or, more generally, the example computing platform 100, is in communication with the web servers 110a-c and the example clinical records system 118 via a network 120 such as, for example, a Wide Area Network (WAN) such as a private network or the Internet. More generally, any of the coupling(s) described herein may be via a network. In such instances, the network may be implemented by, for example, the Internet, an intranet, a virtual private network, a wired or wireless Local Area Network, and/or a wired or wireless Wide Area Network. The example adaptive search module 108 is also in direct communication with the clinical records system 118 via a coupling 122 (e.g., when the computing platform 100 is part of a broader system including the clinical record system 118).

FIG. 2 is a block diagram of an example apparatus that may be used to implement the example adaptive search module 108 of FIG. 1. The example adaptive search module 108 of FIG. 2 includes a communication interface 200 to facilitate communication with, for example, a computing device implementing a user interface with which a searcher (i.e., a person or system conducting a search) can interact. The user interface may be, for example, a webpage for a web-based search engine, an interface dedicated to particular internal search system, and/or any other type of user interface configured to receive query terms from a user and to provide the entered query terms to a search service. In the illustrated example, the communication interface 200 is in communication with a user interface implemented via the operating system 102 and the display(s) and/or output devices(s) 104 of FIG. 1. However, the example communication interface 200 can send and receive data to and from any other device implementing a search interface (e.g., devices external to the example computing platform 100 such as, for example, machines authorized to access the adaptive search module 108 located at a library, personal computers authorized to access the adaptive search module 108 over a network, etc.).

The example communication interface 200 of FIG. 2 receives identifying data indicative of an identity of the searcher and forwards the same to a user identifier 202. The identifying data can be received by the communication interface 200 via, for example, a log in process and/or entry of the identifying data by the searcher in association with the received searched query terms. The example user identifier 202 requests information from an identification database 204 to interpret the identifying data and/or to retrieve information related to an identification of the searcher. In the illustrated example, the identification database 204 includes mappings that link received instances of identifying data (e.g., the type of identifying data received from the searcher and a system being used by the searcher) to identifiers associated with healthcare practitioners. The example identification database 204 of FIG. 2 also includes information related to each identifier such as, for example, a structural role (e.g., physician, radiologist, surgeon, registered nurse, etc.) of the practitioner associated with an identifier, a functional role (e.g., attending physician, attending surgeon, chief radiologist, head nurse, etc.) of the practitioner associated with the identifier, one or more typical responsibilities of a practitioner in that structural or functional role, one or more responsibilities specifically assigned to the identified practitioner. Therefore, in response to receiving the identifying data from the user identifier 202, the example identification database 204 of FIG. 2 returns an identification (e.g., name and/or identifier) of the searcher, one or more roles of the searcher, and/or one or more responsibilities associated with the searcher.

The example communication interface 200 of FIG. 2 also receives query terms (e.g., words and/or phrases) that were the basis of a performed search entered by the searcher and forwards the searched query terms to a search term counter 206. Additionally, the search term counter 206 communicates with the user identifier 202 to obtain a role associated with the searcher. Using the received searched query term and the role of the searcher, the example search term counter 206 increments role-based search statistics 208 stored in a prior search activity database 210. The role-based search statistics 208 include data structure(s) storing a plurality of entries, each corresponding to a healthcare-related role (e.g., a structural role or a functional role). For each role, the role-based search statistics 208 include a plurality of counters, each corresponding to a query term (e.g., a word or phrase). Every time a searcher of a first role runs a search for a first query term, a counter associated with the first role is incremented for the first query term. For example, when a radiologist conducts a search using the search term ‘bone spurs,’ the search term counter 206 increments (or creates if one does not exist) a counter in the role-based search statistics 208 associated with the role ‘radiologist’ for the search term ‘bone spurs.’ Thus, the search term counter 206 and the role-based search statistics 208 track the number of times searchers of particular roles searched for particular terms (i.e., words or phrases).

The example adaptive search module 108 of FIG. 2 includes a search director 212 in communication with the user identifier 202 and the prior search activity database 210. Generally, the example search director 212 of FIG. 2 receives characters typed into a search field by a searcher and uses the received characters to suggest one or more query terms to the searcher likely to be of interest to the searcher based on a role of the searcher. To do so, the example search director 212 obtains a role of the searcher via the user identifier 202 and uses the received role information to query the role-based search statistics 208 of the prior search activity database 210. As described above, the role-based search statistics include data regarding query terms frequently or commonly used by searchers of certain roles. Thus, using the role of the searcher from the user identifier 202, the search director 212 is aware of query terms that searchers having similar responsibilities and interests as the current searcher frequently or commonly use in searches. This knowledge is utilized by a term selector 214 of the example search director 212 to select one or more query terms to suggest to the searcher while the searcher is entering characters into a search field and/or after the searcher has performed a search. In the illustrated example, the term selector 214 receives characters (e.g., ASCII characters corresponding to numbers or letters) typed into a search field by the searcher. That is, as the searcher types (e.g., via the input device(s) 106 of FIG. 1) a word or phrase into the search field, the typed character(s) are conveyed to the term selector 214.

The example term selector 214 compares the typed character(s) to the content of the role-based search statistics 208 to identify one or more query terms to suggest to the searcher for use in a search. In particular, the term selector 214 compares the typed character(s) to entries of the role-based search statistics 208 corresponding to the role of the searcher. When the typed character(s) correspond to a first portion of a query term (e.g., a word or phrase) frequently or commonly used by searcher of a similar role as the current searcher, the example term selector 214 of FIG. 2 communicates that query term to the searcher as a suggestion to be used in the search. For example, the term selector 214 can include the suggestions in a drop-down menu extending from the search field. The order of the suggested query terms can be dictated by the counters of the role-based search statistics 208, the more frequently searched query terms being placed at the top of a list in the drop-down menu. Additionally or alternatively, the example term selector 214 can auto-complete an entry into the search field extending from the typed character(s) already present in the search field. The suggested query term used in the auto-completion of the typed characters can be, for example, the highest query term in the order described above. Thus, as the searcher types characters into the search field, he or she is presented with query terms that the searcher, being of a certain role, is likely or recommended to use in a search.

In some examples, the term selector 214 also references a clinical terminology database 216 before and/or in conjunction with presenting the suggested query terms to the searcher. The example healthcare terminology database 216 includes a plurality of terms related to healthcare systems, devices, practices, procedures, protocols, services, etc. The terms of the healthcare terminology database 216 are controlled terms from a lexicon predefined to include only a set of terms usable to query certain systems, sources and/or types of system or sources. For example, the healthcare terminology database 216 can include a collection of SNOMED CT® (Systematized Nomenclature of Medicine Clinical Terms) terms, a dataset of LOINC® (Logical Observation Identifiers Names and Codes) terms, and/or collections of terms associated with other structured systems (e.g., ICD-9 (International Statistical Classification of Diseases and Related Health Problems), ICD-10, UMLS (Unified Medical Language System), CPT (Current Procedural Terminology), or FDB). The contents of the example healthcare terminology database 216 can be used to filter the suggestions provided to the searcher by the term selector 214. For example, before presenting the query term(s) via the role-based search statistics 208, the example term selector 214 of FIG. 2 can verify that the query term(s) are or correspond to terms of the healthcare terminology 214 (e.g., in situations in which the searcher has designated certain system as the sources to be searched).

The example term selector 214 can also utilize the example healthcare terminology database 216 in additional or alternative manners to screen and/or supplement the suggestions to be provided to the searcher. For example, in some instances, the example term selector 214 is configured to provide suggestions from the healthcare terminology database 216 when no suggestions are available via the role-based search statistics 208. In some instances, the example term selector 214 is configured to provide suggestions from the healthcare terminology database 216 when the amount of suggestions provided by the role-based search statistics 208 is lower than a threshold. In some instances, the example term selector 214 is configured to provide suggestions from the healthcare terminology 216 in lieu of the suggestions provided by the role-based search statistics 208. Any of these and/or other configurations of the example term selector 214 of FIG. 2 are customizable by, for example, the searcher and/or an administrator of the adaptive search module 108 (e.g., according to an access or permission level of the searcher).

In some examples, the term selector 214 also references a system including content model terminology stored in a database 218 before and/or in conjunction with presenting suggested query terms to the searcher. The example content model terminology database 218 includes and/or links to a plurality of content or clinical element models, each having one or more healthcare related terms associated therewith. The content models include terms and/or instructions for execution with respect to terms that can be used in a search, as well as data indicative of a relationship between various terms. That is, the content models on which the corresponding database 218 is based include pieces of data (e.g., words or phrases that can be used as query terms) and indications of relationships (if any) among the pieces of data. A content model can include a word or phrase as well as additional information and/or modifier(s) that explain a behavior, context, role, and/or relationship of the word or phrase to another content model, for example. The content model can include one or more rules or instructions that tell the example term selector 214 how to interpret, relate, and/or connect the content model data to other data, for example. The content model allows a word or phrase and associated parameters and/or instructions to be represented in a structured, searchable, and relatable manner. The example term selector 214 can use the data and additional found in one or more content models in the database 218 to construct a suggested search query for a particular role and/or context, for example.

The example term selector 214 uses the pieces of data and the indications of relationships between the pieces of data to supplement and/or tailor the suggestions to be provided to the searcher. For example, if one of the query terms to be suggested to the searcher from the prior search activity database 210 is also found in the content model terminology database 218, the database 218 can return one or more additional terms related to the matching query term to the term selector 214. The example term selector 214 can supplement the matching query term with the related terms from content model database 218 as additional or alternative suggestions.

The example prior search activity database 210 also includes selection statistics 220 that store data structure(s) that include identifiers of a plurality of sources (e.g., databases, web servers, and/or any other collections of data). To update and maintain the selection statistics 220, the example adaptive search module 108 of FIG. 2 includes a selection counter 222. The example selection counter 222 receives selections from the communication interface 200 that correspond to selections made by the searcher of files, websites, destinations, etc. from, for example, a search results page displayed to the searcher by the display(s) and/or output device(s) 104 of FIG. 1. The example selection counter 222 is capable identifying a source of the selected file, website, destination, etc. The source of the selection may be, for example, one of the web servers 110, the clinical records system 118, and/or any other database, file server, etc. As shown in FIG. 2, the example selection counter 222 also communicates with the user identifier 202 to obtain a role associated with the searcher. Using the identified source and the role of the searcher, the example selection counter 222 increments counters stored in the selection statistics 212. For example, each time a radiologist selects a file stored in a first one of the web servers 110a, the selection counter 222 increments a running counter of the selection statistics 220 associated with radiologists and corresponding to the first web server 110a. Thus, the selection statistics 220 track the amount of times searchers of particular roles select files stored in particular data sources (e.g., databases, file servers, etc.).

To utilize the information of the selection statistics 220, the example adaptive searching module 108 of FIG. 2 includes a set of search pointers 224 implemented in the example search director 212. The example search pointers 224 obtain a role of a current searcher from the user identifier 202 and uses the role of the searcher in conjunction with data obtained from the selection statistics 220. In particular, the role of the current searcher is used to identify one or more data sources frequently or commonly selected by searchers having a similar role as the current searcher. The example search pointers 224 can be referenced by a device implementing a search to direct a searcher to the identified data sources. As a result, the searches performed for the searcher are directed to data sources (e.g., one or more of the RIS 112, the HIS 114, the PACS 116 and/or other components of the clinical record system 118) frequently or commonly selected by searchers having a similar role as the current searcher. The data sources provided by the example search pointers 224 can be searched in addition to or in lieu of other data sources that would have otherwise been searched. When the data sources identified by the example search pointers 224 are used to supplement a search, results from the data sources identified by the search pointers 224 can be displayed to the searcher in a dedicated section of a results page, at the top of a results list, and/or otherwise highlighted.

While an example manner of implementing the adaptive search module 108 of FIG. 1 has been illustrated in FIG. 2, one or more of the elements, processes and/or devices illustrated in FIG. 2 may be combined, divided, re-arranged, omitted, eliminated and/or implemented in any other way. Further, the example communication interface 200, the example user identifier 202, the example search term counter 204, the example search director 212, the example term selector 214, the example selection counter 222, the example search pointers 224, and/or, more generally, the example adaptive search module 108 of FIG. 2 may be implemented by hardware, software, firmware and/or any combination of hardware, software and/or firmware. Thus, for example, any of the example communication interface 200, the example user identifier 202, the example search term counter 204, the example search director 212, the example term selector 214, the example selection counter 222, the example search pointers 224, and/or, more generally, the example adaptive search module 108 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example communication interface 200, the example user identifier 202, the example search term counter 204, the example search director 212, the example term selector 214, the example selection counter 222, the example search pointers 224, and/or, more generally, the example adaptive search module 108 of FIG. 2 are hereby expressly defined to include a tangible medium such as a memory, DVD, CD, Blue-Ray, etc., storing the software and/or firmware. Further still, the example adaptive search module 108 of FIG. 2 may include one or more elements, processes and/or devices in addition to, or instead of, those illustrated in FIG. 2, and/or may include more than one of any or all of the illustrated elements, processes and devices. Further, the databases and/or storage devices (i.e., the example identification data database 204, the example prior search activity database 210, the example role-based search statistics 208, the example selection statistics 220, the example healthcare terminology database 216, the example content model terminology database 218) of FIG. 2 may be implemented using any number and/or type(s) of data structures, entries, tables, record keeping systems, memory(-ies), memory device(s) and/or storage device(s).

FIGS. 3-5 are flow diagrams representative of example machine readable instructions that may be executed to implement the example adaptive search module 108 of FIGS. 1 and/or 2. The example processes of FIGS. 3-5 may be performed using a processor, a controller and/or any other suitable processing device. For example, the example processes of FIGS. 3-5 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIGS. 3-5 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 3-5 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 3-5 may be implemented manually or as any combination(s) of any of the foregoing techniques, for example, any combination of firmware, software, discrete logic and/or hardware. Further, although the example processes of FIGS. 3-5 are described with reference to the flow diagrams of FIGS. 3-5, other methods of implementing the processes of FIGS. 3-5 may be employed. For example, the order of execution of the blocks may be changed, and/or some of the blocks described may be changed, eliminated, sub-divided, or combined. Additionally, any or all of the example processes of FIGS. 3-5 may be performed sequentially and/or in parallel by, for example, separate processing threads, processors, devices, discrete logic, circuits, etc.

The flow diagram of FIG. 3 corresponds to example processes to be performed by and/or in association with the example search term counter 206 of FIG. 2. The example flow diagram of FIG. 3 begins with the communication interface 200 forwarding a searched query term to the search term counter 206 (block 300). A searcher may have entered the searched query term into a search field of any type of search service or system that queried one or more resources using the searched query term. The example search term counter 206 also obtains a role associated with the searcher that entered the searched query term via the user identifier 202 (block 302). The example search term counter 206 then determines whether the role-based search statistics 208 of the prior search activity database 210 includes an entry for the received searched query term in association with the obtained role of the searcher (block 304). In other words, the search term counter 206 determines whether the prior search activity database 210 indicates that a searcher having a role of the current searcher previously performed a search with the received searched query term. If not, the example search term counter 206 creates an entry in the role-based search statistics 208 and initiates a corresponding counter (block 306). Then, whether the entry for the received searched query term in the role-based search statistics 208 was initiated or previously existed, the search term counter 206 increments that counter (block 306). As a result, the search term counter 206 and the role-based search statistics 208 track the number of times searchers of particular roles searched for particular terms (i.e., words or phrases). The example flow diagram of FIG. 3 then ends (block 310).

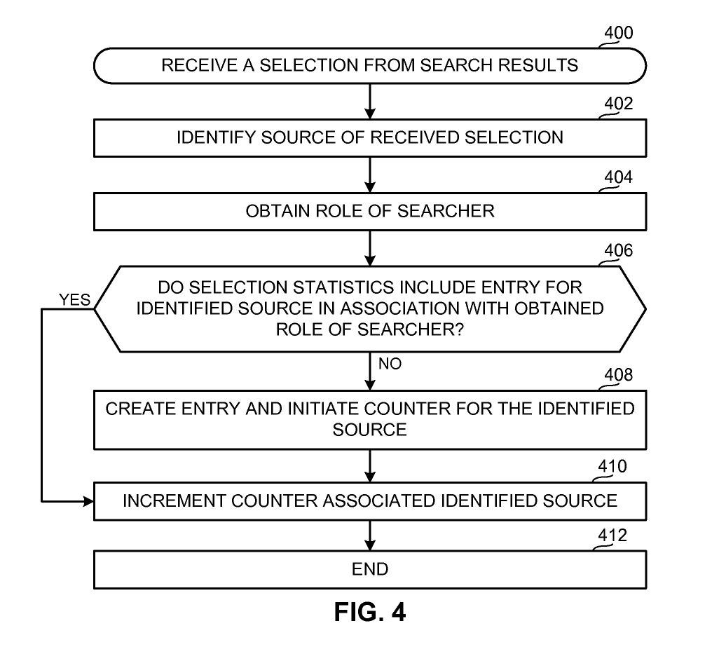

The flow diagram of FIG. 4 corresponds to example processes to be performed by and/or in association with the example selection counter 222 of FIG. 2. The example flow diagram of FIG. 4 begins with the communication interface 200 forwarding a selection from search results to the selection counter 222 (block 400). For example, a searcher may have selected a link on a search results page generated in response to a search for certain query term(s). The corresponding search service or system may have queried one or more resources using the query term(s). The example selection counter 222 then identifies a source of the received selection (block 402). For example, the selection counter 222 may determine that one of the web server 110a-c of FIG. 1 and/or one of the components of the clinical records system 118 is the source for the selection made by the searcher. The example selection counter 222 also obtains a role associated with the searcher that made the selection via the user identifier 202 (block 404). The example selection counter 222 then determines whether the selection statistics 220 of the prior search activity database 210 includes an entry for the identified source of the selection in association with the obtained role of the searcher (block 406). In other words, the selection counter 222 determines whether the prior search activity database 210 indicates that a searcher having a role of the current searcher previously selected a search result having the identified source. If not, the example selection counter 222 creates an entry in the selection statistics 220 and initiates a corresponding counter (block 408). Then, whether the entry for the identified source in the selection statistics 220 was initiated or previously existed, the selection counter 222 increments that counter (block 410). As a result, the selection statistics 220 and the selection counter 222 track the amount of times searchers of particular roles select files stored in particular data sources (e.g., databases, file servers, etc.). The example flow diagram of FIG. 4 then ends (block 412).

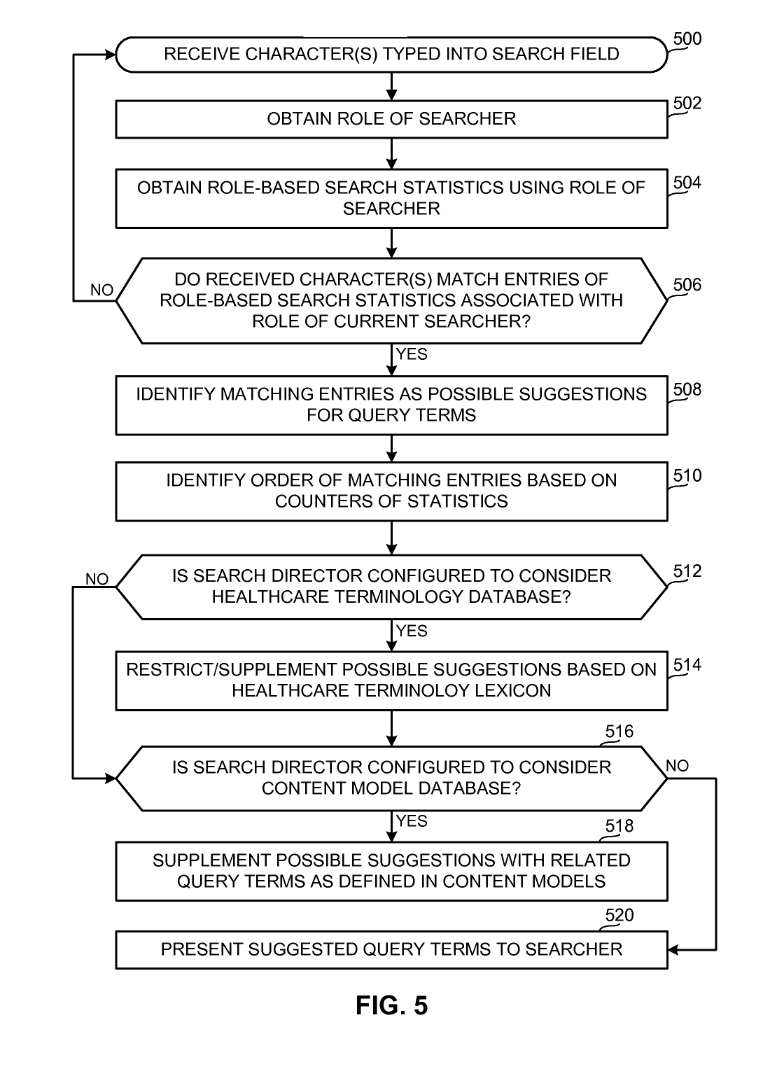

The flow diagram of FIG. 5 corresponds to example processes to be performed by and/or in association with the search director 212 of FIG. 2. The example flow diagram of FIG. 5 begins with the communication interface 200 forwarding characters typed into a search field to the search director 212 (block 500). The characters correspond to portion of a query term typed by a searcher. For example, the searcher may type in the characters ‘bon’ into a search field. Each of these characters is forwarded to the search director 212 as it is typed. Also, the example search director 212 obtains, via the user identifier 202, a role associated with the searcher entering the characters (block 502). For example, the user identifier 202 may determine that the searcher is a radiologist (e.g., from login information or as supplied by the searcher in association with the search service being used). The example term selector 214 of the search director 212 then determines whether the received character(s) match entries of the role-based search statistics 208 associated with the obtained role of the searcher (block 506). That is, the term selector 214 determines whether the typed portion(s) of the query terms being entered by the searcher correspond to portion(s) of query terms frequently or commonly used by searchers having a similar role as the current searcher. If no matches are identified, control returns to block 500 in the example flow diagram of FIG. 3. If the term selector 214 finds one or more matches, the matching entries of the role-based search statistics 208 are identified or designated as possible suggestion query terms to be provided to the searcher (block 508). For example, the term selector 214 may find that the received characters ‘bon’ match entries in the role-based statistics 208 for radiologists, such as ‘bone spurs’ or ‘bone calcification.’ Further, an order or hierarchy for the possible suggestions is identified based on the counters of the role-based search statistics 208 corresponding to the identified query terms (block 510). In other words, when a first one of the matching entries (e.g., bone spurs) of the role-based search statistics 208 has a counter of a first value higher than a second value of a second one of the matching entries (e.g., bone calcification) of the role-based search statistics 208, the first matching entry (e.g., bone spurs) may take priority over the second matching entry as a preferred suggestion. Such a preference is reflected in the order identified at block 510 in the example of FIG. 3.

The example search director 212 then determines whether the example healthcare terminology database 216 is to be considered in providing the suggested query term(s) to the searcher (block 512). If so, the search director 212 references the healthcare terminology database 216 with the suggested query terms obtained by the example term selector 214 to determine whether and/or how the suggested query terms can be supplemented and/or restricted using the controlled lexicon of the healthcare terminology database (block 514). As described above, the healthcare terminology database 216 can provide the searcher with query term(s) designated as acceptable by certain data sources that require certain terms and/or formats for the terms to perform a search. Therefore, the possible suggestions to be provided to the searcher can be further tailored for the searcher when, for example, the searcher plans to limit a search to particular data sources having such requirements.

The example search director 212 then determines whether the example content model terminology database 218 is to be considered in providing the suggested query term(s) to the searcher (block 516). If so, the search director 212 references the content model terminology database 218 with the suggested query terms obtained by the example term selector 214 to determine whether and/or how the suggested query terms can be supplemented and/or restricted using the relationship data of the content model terminology database 218 (block 518). As described above, the content model terminology database 218 includes terms and data indicative of relationship between the terms. The content model can be used to provide a structure for identifying and relating one or more terms for a particular role and/or context, for example. The content model can help to connect and/or suggest other terms related to the content model term, for example. Therefore, the possible suggestions to be provided to the searcher can be further tailored for the searcher by, for example, relating additional possible query terms to those identified by the term selector 214.

The suggested query terms are then presented to the searcher (block 520). For example, the suggestions can be presented in a drop-down menu extending from the search field in which the received character(s) were entered by the searcher. Additionally or alternatively, the suggested query term(s) (e.g., the highest ranked query term according to the counters of the role-based search statistics 208) can be presented as auto-completions of the entry into the search field extending from the typed character(s) already present in the search field. To continue the above example, after the searcher types ‘bon,’ he or she is presented with ‘bone spurs’ as a suggested query term as an auto-completed word in the search field. Additionally, the query term ‘bone calcification’ may be presented to the searcher in a drop down menu adjacent the search field. Thus, as the searcher types characters into the search field, he or she is presented with query terms that the searcher, being of a certain role, is likely or recommended to use in a search. Accordingly, a radiologist, for example, utilizing the methods and apparatus described herein that types the characters ‘bon’ into a search field is presented with suggested query terms such as ‘bone spurs’ and ‘bone calcification’ instead of query terms likely to be irrelevant to a radiologist, such as ‘bon jovi,’ ‘bon appétit,’ or ‘bonnaroo music festival.’

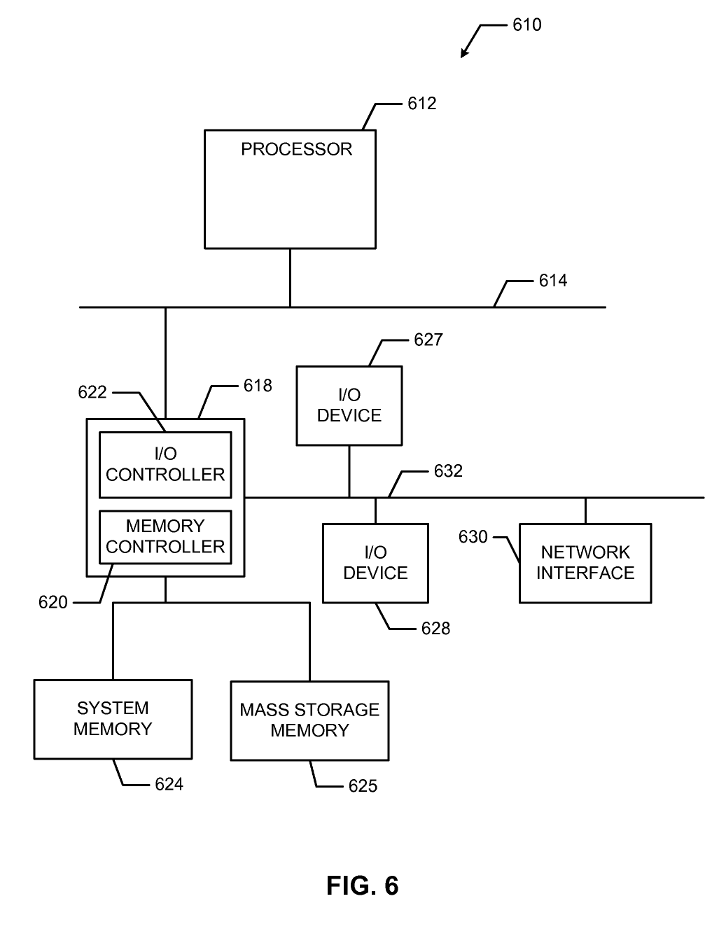

FIG. 6 is a block diagram of an example processor system 610 that may be used to implement the apparatus, methods, systems and/or articles of manufacture described herein. As shown in FIG. 6, the processor system 610 includes a processor 612 that is coupled to an interconnection bus 614. The processor 612 may be any suitable processor, processing unit or microprocessor. Although not shown in FIG. 6, the system 610 may be a multi-processor system and, thus, may include one or more additional processors that are identical or similar to the processor 612 and that are communicatively coupled to the interconnection bus 614.

The processor 612 of FIG. 6 is coupled to a chipset 618, which includes a memory controller 620 and an input/output (I/O) controller 622. As is well known, a chipset typically provides I/O and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SRAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (I/O) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (ATM) device, an 802.11 device, a DSL modem, a cable modem, a cellular modem, etc. that enables the processor system 610 to communicate with another processor system.

While the memory controller 620 and the I/O controller 622 are depicted in FIG. 6 as separate blocks within the chipset 618, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. An apparatus for searching healthcare information systems, comprising:
a search term counter to receive searched query terms and to receive roles of searchers entering the searched query terms, the search term counter to maintain statistics indicative of usage of the searched query terms according to roles of the corresponding searchers;
an interface to receive one or more characters entered into a search field of a search service by a user;
a user identifier to determine a role associated with the user; and
a term selector to reference the statistics using the role associated with the user to identify a query term for suggestion to the user based on the received one or more characters and the role of the user, wherein the interface is to facilitate presentation of the identified query term as a suggestion to the user for the search service.

2. An apparatus as defined in claim 1, further comprising a search director to apply a lexicon of a healthcare terminology database to the identified query term before presenting the query term to the user.

3. An apparatus as defined in claim 2, wherein the lexicon of the healthcare terminology database includes terms defined as acceptable to one or more data sources having requirements for query terms used in querying the one or more data sources.

4. An apparatus as defined in claim 1, further comprising a search director to supplement the query term to be suggested to the user with data from a content model terminology database.

5. An apparatus as defined in claim 4, wherein the content model terminology database includes instances of data and indications of relationships between the instances of data.

6. An apparatus as defined in claim 1, wherein presentation of the identified query term comprises displaying the identified query term as an extension of the one or more characters entered into the search field.

7. An apparatus as defined in claim 1, wherein presentation of the identified query term comprising displaying the identified query term in a drop down menu adjacent the search field.

8. A computer-implemented method for searching healthcare information systems, comprising:
receiving one or more characters entered into a search field of a search service;
identifying a role associated with a user entering the one or more characters into the search field;
selecting a query term to be suggested to the user based on the received one or more characters and the role associated with the searcher; and
facilitating presentation of the selected query term to the user as a suggestion for use in the search service.

9. A method as defined in claim 8, wherein selecting the query term to be suggested to the user comprises referencing a database using the role associated with the user, wherein the database is to store statistics related to searches performed by users of particular roles.

10. A method as defined in claim 8, further comprising applying a lexicon of a healthcare terminology database to the identified query term before presenting the query term to the user.

11. A method as defined in claim 10, wherein the lexicon of the healthcare terminology database includes terms defined as acceptable to one or more data sources having requirements for query terms used in querying the one or more data sources.

12. A method as defined in claim 8, supplementing the query term to be suggested to the user with data from a content model terminology database.

13. A method as defined in claim 12, wherein the content model terminology database includes instances of data and indications of relationships between the instances of data.

14. A method as defined in claim 8, wherein presentation of the identified query terms comprises displaying the identified query term as an extension of the one or more characters entered into the search field.

15. A tangible machine readable medium having instructions stored thereon that, when executed, cause a machine to at least:
receive searched query terms and to receive roles of searchers entering the searched query terms;
maintain statistics indicative of usage of the searched query terms according to roles of the corresponding searchers;
receive one or more characters entered into a search field of a search service by a user;
determine a role associated with the user; and
reference the statistics using the role associated with the user to identify a query term for suggestion to the user based on the received one or more characters and the role of the user, wherein the interface is to facilitate presentation of the identified query term as a suggestion to the user for the search service.

16. A tangible machine readable medium as defined in claim 15 having instructions stored thereon that, when executed, cause a machine to apply a lexicon of a healthcare terminology database to the identified query term before presenting the query term to the user.

17. A tangible machine readable medium as defined in claim 16, wherein the lexicon of the healthcare terminology database includes terms defined as acceptable to one or more data sources having requirements for query terms used in querying the one or more data sources.

18. A tangible machine readable medium as defined in claim 15 having instructions stored thereon that, when executed, cause a machine to supplement the query term to be suggested to the user with data from a content model terminology database.

19. A tangible machine readable medium as defined in claim 18, wherein the content model terminology database includes instances of data and indications of relationships between the instances of data.

20. A tangible machine readable medium as defined in claim 15, wherein presentation of the identified query term comprises at least one of displaying the identified query term as an extension of the one or more characters entered into the search field or displaying the identified query term in a drop down menu adjacent the search field.
